(19) United States
(12) Patent Application Publication
(10) Pub. No.: US 2024/0409368 A1
(43) Pub. Date: Dec. 12, 2024

(54) ELEVATOR SYSTEM INCLUDING PIT SAFETY INTERFACE

(71) Applicant: Otis Elevator Company, Farmington, CT (US)

(72) Inventors: Kathleen Nicole Moore, West Hartford, CT (US); Johanna Whitwell, Hartford, CT (US); Randy Roberts, Hebron, CT (US); James Tilsley Auxier, Palm Beach Gardens, FL (US)

(21) Appl. No.: 18/333,187

(22) Filed: Jun. 12, 2023

(51) Int. Cl. B66B 5/00

(52) U.S. Cl. CPC B66B 5/0056

(57) ABSTRACT

An elevator system includes a hoistway; an elevator car configured to travel in the hoistway; a pit located at a bottom of the hoistway; a pit safety interface located in the pit; a pit emergency switch located in the pit; a reset device located outside the hoistway; a safety chain contact that is part of a safety chain of the elevator system; and a sensor assembly configured to initiate opening the safety chain contact to disable motion of the elevator car upon detection of a person in the pit and the pit safety interface not being activated.

### BACKGROUND

The embodiments described herein relate to elevator systems, and more particularly, to an elevator system including a pit safety interface.

Persons, such as maintenance personnel, may need to enter the pit of an elevator hoistway for inspection, maintenance, etc. Numerous safety measures exist to prevent injury to persons in the pit. Additional safety measures, although not necessary, may be beneficial.

### SUMMARY

According to an embodiment, an elevator system includes a hoistway; an elevator car configured to travel in the hoistway; a pit located at a bottom of the hoistway; a pit safety interface located in the pit; a pit emergency switch located in the pit; a reset device located outside the hoistway; a safety chain contact that is part of a safety chain of the elevator system; and a sensor assembly configured to initiate opening the safety chain contact to disable motion of the elevator car upon detection of a person in the pit and the pit safety interface not being activated.

In addition to one or more of the features described herein, or as an alternative, further embodiments may include wherein the sensor assembly is configured to close the safety chain contact upon completion of a reset function.

In addition to one or more of the features described herein, or as an alternative, further embodiments may include wherein the sensor assembly is configured to enable a temporary manual bypass should a person be detected and the reset function not be engaged.

In addition to one or more of the features described herein, or as an alternative, further embodiments may include wherein the sensor assembly is configured to remain temporarily bypassed while the pit safety interface is activated.

In addition to one or more of the features described herein, or as an alternative, further embodiments may include wherein the sensor assembly is configured to close the safety chain contact while the pit safety interface is activated.

In addition to one or more of the features described herein, or as an alternative, further embodiments may include wherein the sensor assembly is configured to exit the bypass mode and open the safety chain contact when the sensor assembly senses a person in the pit and the pit safety interface is not activated.

In addition to one or more of the features described herein, or as an alternative, further embodiments may include wherein the sensor assembly includes a sensor that measures distances to objects in the pit.

In addition to one or more of the features described herein, or as an alternative, further embodiments may include wherein the sensor includes at least one of a LIDAR sensor, a millimeter wave RADAR sensor and an RGBD camera.

According to another embodiment, a method of operating an elevator system including a hoistway, an elevator car configured to travel in the hoistway, a pit located at a bottom of the hoistway, a pit safety interface located in the pit, a safety chain contact part of a safety chain of the elevator system, and a sensor assembly, the method including
detecting, by the sensor assembly, a person in the pit; and
opening the safety chain contact to disable motion of the elevator car upon detection of a person in the pit and the pit safety interface not being activated.

In addition to one or more of the features described herein, or as an alternative, further embodiments may include the sensor assembly closing the safety chain contact upon completion of a reset function.

In addition to one or more of the features described herein, or as an alternative, further embodiments may include the sensor assembly enabling a temporary manual bypass should a person be detected and the reset function not be engaged.

In addition to one or more of the features described herein, or as an alternative, further embodiments may include the sensor assembly remaining temporarily bypassed while the pit safety interface is activated.

In addition to one or more of the features described herein, or as an alternative, further embodiments may include the sensor assembly closing the safety chain contact while the pit safety interface is activated.

In addition to one or more of the features described herein, or as an alternative, further embodiments may include the sensor assembly exiting the bypass mode and open the safety chain contact when the sensor assembly senses a person in the pit and the pit safety interface is not activated.

In addition to one or more of the features described herein, or as an alternative, further embodiments may include wherein the sensor assembly includes a sensor that measures distances to objects in the pit.

In addition to one or more of the features described herein, or as an alternative, further embodiments may include wherein the sensor includes at least one of a LIDAR sensor, a millimeter wave RADAR sensor and an RGBD camera.

According to another embodiment, a computer program embodied on a non-transitory computer-readable storage medium, the computer program including instructions for causing a processor to implement a process for operating an elevator system including a hoistway, an elevator car configured to travel in the hoistway, a pit located at a bottom of the hoistway, a pit safety interface located in the pit, a safety chain contact part of a safety chain of the elevator system, and a sensor assembly, the process including detecting, by the sensor assembly, a person in the pit; and opening the safety chain contact to disable motion of the elevator car upon detection of a person in the pit and the pit safety interface not being activated.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts an elevator system that may employ various embodiments of the present disclosure;

FIG. 2 depicts an elevator pit in accordance with an embodiment;

FIG. 3 depicts a sensor assembly in accordance with an embodiment; and

FIG. 4 depicts a flowchart of a process for controlling movement of an elevator car in accordance with an embodiment.

### DETAILED DESCRIPTION

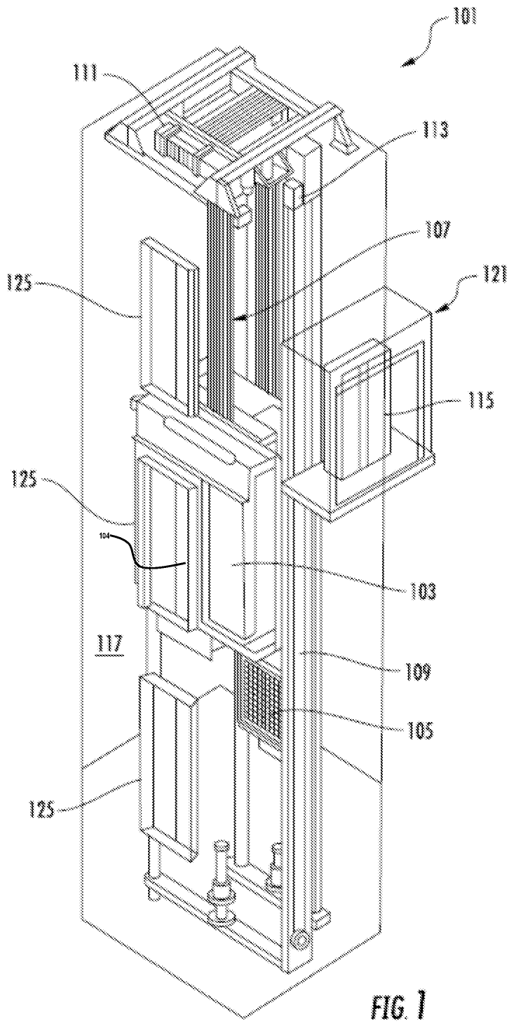

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft or hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the elevator shaft 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

The elevator system 101 also includes one or more elevator doors 104. The elevator door 104 may be attached to the elevator car 103 or the elevator door 104 may be located on a landing 125 of the elevator system 101, or both. Embodiments disclosed herein may be applicable to both an elevator door 104 attached to the elevator car 103 or an elevator door 104 located on a landing 125 of the elevator system 101, or both. The elevator door 104 opens to allow passengers to enter and exit the elevator car 103.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is a non-limiting example presented for illustrative and explanatory purposes.

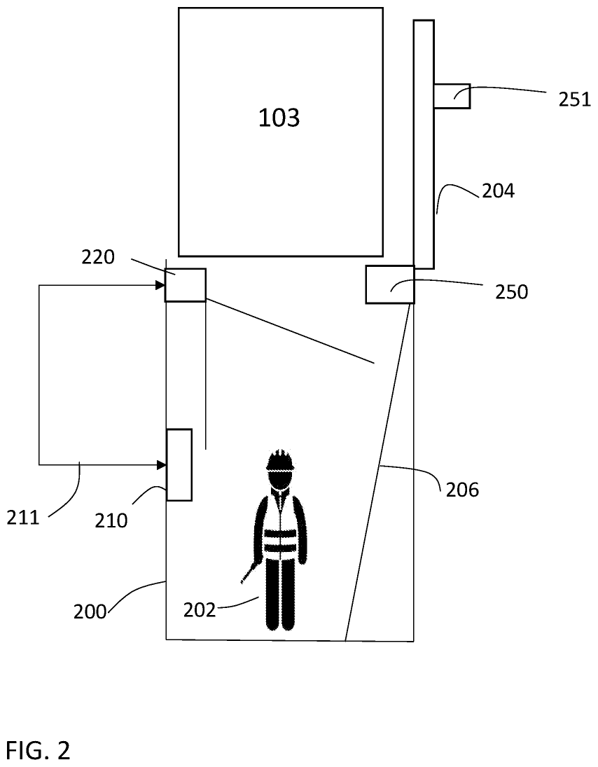

FIG. 2 depicts an elevator pit 200 in an example embodiment. The elevator pit 200 is located at the bottom of the hoistway 117 and includes equipment that may need to be accessed or inspected by a person 202. Access to the pit 200 is through an access door 204, which may be a door at the lowest landing of the building or another door. A ladder 206 provides for entry to and exit from the pit 200. A pit emergency switch 250 is provided in the pit 200, typically located at the top of the ladder 206. In standard pit access procedures, the pit emergency switch 250 is manually operated by the person 202 before they enter the pit 200 to put the elevator into an operation mode in which elevator car 103 is not able to move. In addition, a sensor assembly 220 monitors the pit 200 for the presence of person(s) 202. A pit safety interface 210 is provided in the pit 200. The pit safety interface 210 is manually operated by the person 202 to enter an operating mode in which the person 202 is in the pit 200 and the elevator car 103 is able to move. A reset device 251 is provided outside of the access door 204, in the vicinity of, or proximate to, the pit entrance. The reset device 251 is manually operated by the person 202 when the sensor assembly 220 needs to be put back in an operational mode.

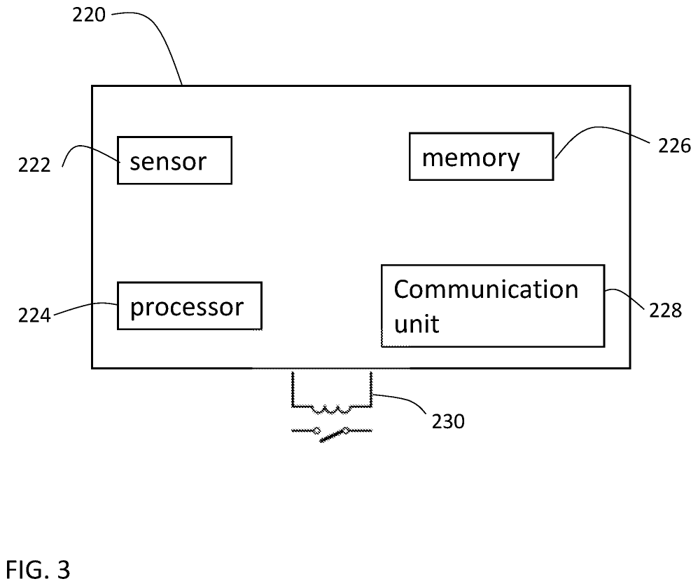

FIG. 3 depicts a sensor assembly 220 in an example embodiment. The sensor assembly 220 includes one or more sensors 222. The sensor 222 may be a distance sensor that generates distance measurements in a two-dimensional or three-dimensional field of view. The sensor 222 may be implemented using a LIDAR sensor, a millimeter wave RADAR sensor, an RGBD camera or other distance measuring sensors. The sensor assembly 220 includes a processor 224 that controls operation of the sensor assembly 220. The processor 224 may be implemented using a general-purpose microprocessor executing a computer program stored on a storage medium to perform the operations described herein. Alternatively, the processor 224 may be implemented in hardware (e.g., ASIC, FPGA) or in a combination of hardware/software. The processor 224 allows the sensor assembly 220 to perform computations locally, also referred to as edge computing. The processor 224 can send commands to other components of the elevator system 101 based on a result of the local computations.

The sensor assembly 220 includes a memory 226 that may store a computer program executable by the processor 224, reference data, sensor data, etc. The memory 226 may be implemented using known devices such a random access memory. The sensor assembly 220 includes a communication unit 228 which allows the sensor assembly 220 to communicate with other components of the elevator system 101, such as other sensor assemblies and/or the elevator controller 115. The communication unit 228 may be implemented using wired connections (e.g., LAN, ethernet, twisted pair, etc.) and/or wireless connections (e.g., WiFi, NFC, BlueTooth, etc.).

In operation, the sensor assembly 220 can open a safety chain of the elevator system 101 under certain conditions. A safety chain is a known component of elevator systems, and typically includes a number of contacts (e.g., relays) in series that control power to the elevator system machine 111 to enable or disable movement of the elevator car 103. If any of the contacts of the safety chain are open, then the elevator car 103 is prevented from moving. In an example embodiment, the sensor assembly 220 can control a safety chain contact 230 in order to open or close the safety chain. It is understood that safety chain contact 230 is one of several contacts making up the safety chain.

The pit safety interface 210 may be a manually operated switch, touch panel, console or other input mechanism that is used to temporarily bypass the sensor assembly's automatic response to open the safety chain contact 230. When the pit safety interface 210 is activated (e.g., by continuously maintaining contact with one or more buttons), a signal is presented to the sensor assembly 220. The pit safety interface 210 may be in communication with the sensor assembly 220 over a wired connection 211. The pit safety interface 210 may be in communication with the sensor assembly 220 over a wireless connection. The pit safety interface 210 allows the person 202 to be in the pit 200 and still allow movement of the elevator car 103. This may be useful, for example, in situations where the person 202 needs to perform an inspection of the elevator system 101 while the elevator car 103 is moving.

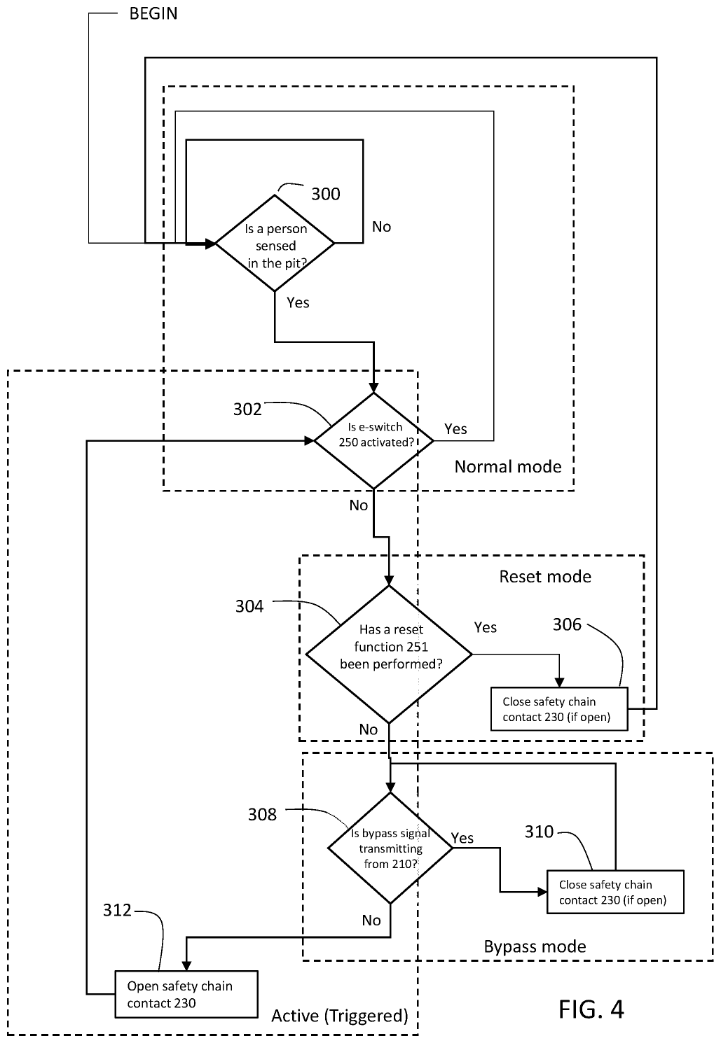

FIG. 4 depicts a flowchart of a process performed by the sensor assembly 220 for allowing controlled movement of an elevator car 103 in an example embodiment. The process is designed to ensure that if the person 202 is in the pit 200, the elevator car 103 can be moved only while the pit safety interface 210 is transmitting the bypass signal. When the sensor assembly 220 is activated (e.g., initial installation, restart after power loss, etc.), the process is started as shown at BEGIN in FIG. 4.

At 300, the sensor assembly 220 determines if a person 202 is in the pit 200. This state of operation is referred to as normal mode of operation. Reference to detecting a person 202 in the pit 200 includes detecting the person 202 at one or more of the pit ladder 206, a pit entrance (e.g., perimeter of the pit 200) or a pit area (e.g., as much of the pit 200 are as possible). A number of points within a certain distance (e.g., within the interior walls of the pit) greater than a threshold indicates a person 202 is in the pit 200. Background distance measurements are collected to establish the baseline when no person 202 is in the pit 200. A person 202 can then be classified by the processor 224 as they appear in the foreground (in front of) the learned ambient background. In one example, the distance measurements define a point cloud in the field of view. A number of points within a certain distance (e.g., within the interior walls of the pit) greater than the threshold indicates a person is in the pit 200. The presence or a direction of travel of the person 202 may also be determined (e.g., by comparing point distributions across multiple frames of a field of view) to verify if person 202 is present in the pit 200.

If, at 300, no person 202 is present in the pit 200, the process loops until a person 202 is detected. Once a person 202 is detected in the pit 200, flow proceeds to 302 where the sensor assembly 220 determines if the pit emergency switch 250 is activated (e.g., car movement stopped). If yes, the process loops back to 300.

If at 302, the pit emergency switch 250 is not activated, flow proceeds to 304 where the sensor assembly 220 determines if a reset function has been performed. The reset function may be performed in a variety of ways, including manual and/or automatic. A manual reset includes a person performing a reset action (e.g., press reset button on the reset device 251 upon confirming an “all clear” status). An automatic reset may include the sensor assembly 220 determining, with some high level of confidence, that no one is in the pit 200. In either reset example described above and as shown in the embodiment in FIG. 4, the reset function serves as an interrupt and not a latching state, and thusly returns execution to Normal mode upon closure of the safety chain at 306.

If a reset has been performed at 304, flow proceeds to 306 where the sensor assembly 220 closes the safety chain contact 230 (if open). Flow the returns to 300.

If at 304, the sensor assembly 220 determines that a reset function has not been performed, flow proceeds to 308 where the sensor assembly 220 determines if a bypass signal is being transmitted from the pit safety interface 210. Activation of the pit safety interface 210 enables bypass at 308, at which point flow proceeds to 310 where the sensor assembly 220 temporarily closes the safety chain contact 230 (if open). The sensor assembly 220 remains temporarily bypassed at 308 until the sensor assembly 220 no longer receives a bypass signal from the pit safety interface 210 at which point the process flows to 312. The bypass signal from the pit safety interface 210 is only transmitted so long as the interface 210 is actively engaged by the person 202 in the pit 200.

At 312, the sensor assembly 220 opens the safety chain contact 230. At this stage, the sensor assembly 220 is in an active (triggered) mode. From 312, the process returns to 302.

Embodiments described herein allow necessary service tasks to be conducted safely even when detection mechanisms are implemented (e.g., opening safety chain via relay).

As described above, embodiments can be in the form of processor-implemented processes and devices for practicing those processes, such as a processor 224 in the sensor assembly 220. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes a device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system comprising:
a hoistway;
an elevator car configured to travel in the hoistway;
a pit located at a bottom of the hoistway;
a pit safety interface located in the pit;
a pit emergency switch located in the pit;
a reset device located outside the hoistway;
a safety chain contact that is part of a safety chain of the elevator system; and
a sensor assembly configured to initiate opening the safety chain contact to disable motion of the elevator car upon detection of a person in the pit and the pit safety interface not being activated.

2. The elevator system of claim 1, wherein the sensor assembly is configured to close the safety chain contact upon completion of a reset function.

3. The elevator system of claim 2, wherein the sensor assembly is configured to enable a temporary manual bypass should a person be detected and the reset function not be engaged.

4. The elevator system of claim 3, wherein the sensor assembly is configured to remain temporarily bypassed while the pit safety interface is activated.

5. The elevator system of claim 4, wherein the sensor assembly is configured to close the safety chain contact while the pit safety interface is activated.

6. The elevator system of claim 3, wherein the sensor assembly is configured to exit the bypass mode and open the safety chain contact when the sensor assembly senses a person in the pit and the pit safety interface is not activated.

7. The elevator system of claim 1, wherein the sensor assembly includes a sensor that measures distances to objects in the pit.

8. The elevator system of claim 7, wherein the sensor includes at least one of a LIDAR sensor, a millimeter wave RADAR sensor and an RGBD camera.

9. A method of operating an elevator system including a hoistway, an elevator car configured to travel in the hoistway, a pit located at a bottom of the hoistway, a pit safety interface located in the pit, a safety chain contact part of a safety chain of the elevator system, and a sensor assembly, the method comprising:
detecting, by the sensor assembly, a person in the pit; and
opening the safety chain contact to disable motion of the elevator car upon detection of a person in the pit and the pit safety interface not being activated.

10. The method of claim 9, further comprising the sensor assembly closing the safety chain contact upon completion of a reset function.

11. The method of claim 10, further comprising the sensor assembly enabling a temporary manual bypass should a person be detected and the reset function not be engaged.

12. The method of claim 11, further comprising the sensor assembly remaining temporarily bypassed while the pit safety interface is activated.

13. The method of claim 12, further comprising the sensor assembly closing the safety chain contact while the pit safety interface is activated.

14. The method of claim 11, further comprising the sensor assembly exiting the bypass mode and open the safety chain contact when the sensor assembly senses a person in the pit and the pit safety interface is not activated.

15. The method of claim 9, wherein the sensor assembly includes a sensor that measures distances to objects in the pit.

16. The method of claim 15, wherein the sensor includes at least one of a LIDAR sensor, a millimeter wave RADAR sensor and an RGBD camera.

17. A computer program embodied on a non-transitory computer-readable storage medium, the computer program including instructions for causing a processor to implement a process for operating an elevator system including a hoistway, an elevator car configured to travel in the hoistway, a pit located at a bottom of the hoistway, a pit safety interface located in the pit, a safety chain contact part of a safety chain of the elevator system, and a sensor assembly, the process comprising:
detecting, by the sensor assembly, a person in the pit; and
opening the safety chain contact to disable motion of the elevator car upon detection of a person in the pit and the pit safety interface not being activated.
